(19) United States
(12) Patent Application Publication
(10) Pub. No.: US 2019/0262707 A1
(43) Pub. Date: Aug. 29, 2019

(54) METHOD AND SYSTEM OF CREATING A NETWORK TO FACILITATE A MULTIPLAYER GAME

(71) Applicant: CINIME ASIA PACIFIC PTE. LTD., Singapore (SG)

(72) Inventor: Tom CAMPBELL, Singapore (SG)

(21) Appl. No.: 16/228,947

(22) Filed: Dec. 21, 2018

Related U.S. Application Data
(63) Continuation of application No. 15/657,453, filed on Jul. 24, 2017, now abandoned.
(60) Provisional application No. 62/367,281, filed on Jul. 27, 2016.

(51) Int. Cl. A63F 13/31; A63F 13/34

(52) U.S. Cl. CPC A63F 13/31; A63F 13/352; A63F 2300/408; A63F 13/34

(57) ABSTRACT

A method or system for building a network between a plurality of portable computing devices to facilitate a multiplayer game includes each portable computing device: receiving an audio signal at a microphone at the device; matching the audio signal to one of a plurality of pre-stored games, each game associated with a game network identifier; creating a new network identifier utilising the matched game network identifier; and creating a network using the new network identifier if the network does not exist or joining the network using the new network identifier if the network does exist.

### CROSS REFERENCE TO RELATED APPLICATIONS

This application is a continuation of U.S. patent application Ser. No. 15/657,453, filed Jul. 24, 2017, which claims the benefit of U.S. Provisional Application No. 62/367,281 filed Jul. 27, 2016, the entire contents of each of which are hereby incorporated by reference.

### FIELD OF INVENTION

The present invention is in the field of multiplayer game systems. More particularly, but not exclusively, the present invention relates to a method and system for creating a network between a plurality of portable computing devices to facilitate a multiplayer game.

### BACKGROUND

In the field of multiplayer game systems, there exist several architectures to facilitate communication and/or coordination between players of a multiplayer game.

Game consoles are one example of these architectures. Game consoles for multiplayer gaming provide a central processing apparatus, a display and a plurality of handheld controllers. These handheld controllers receive input from a user and transmit the input back to the central processing apparatus which generates game-play images for the display. The handheld controllers are typically connected via a wired communications protocol such as USB, but may be connected via a wireless protocol such as Bluetooth. A standard handshaking protocol is utilised between the game console and the handheld controller when the game console or handheld controller is powered up or when the handheld controller is physically connected to the game console. Disadvantages of this architecture are the requirement for a locally accessible game console, scaling constraints (most consoles are unable to provide for more than four controllers), and limitations on gameplay (visual information is only provided on a single display).

Another example involves a remote server which facilitates communication and/or coordination between a plurality of portable computing devices, such as mobile phones. An app executes on each mobile phone and gameplay data is transmitted to the remote server. The remote server processes the gameplay data and transmits information relating to the processed gameplay data to the portable computing devices. To connect to the remote server, the app executing on the portable computing device provides authentication information to the remote server over a local wireless network or over a cellular network. Disadvantages of this architecture are the requirements for continuous communication to the remote server, latency in communication to/from a remote server, and possible bottlenecks in the communications channel or at the remote server.

Therefore there is a desire for an improved multiplayer game system which may be more easily deployed, which accommodates localised communications limitations such as poor cellular reception or capacity, and which provides for large numbers of simultaneous players. Such an improved system could be usefully utilised within a cinema auditorium or stadium.

It is an object of the present invention to provide a method and system for creating a network to facilitate a multiplayer game which overcomes the disadvantages of the prior art, or at least provides a useful alternative.

### SUMMARY OF INVENTION

According to a first aspect of the invention there is provided a method of building a network between a plurality of portable computing devices to facilitate a multiplayer game, including:
each portable computing device:

receiving an audio signal at a microphone at the device;

matching the audio signal to one of a plurality of pre-stored games, each game associated with a game network identifier;

creating a new network identifier utilising the matched game network identifier; and

creating a network using the new network identifier if the network does not exist or joining the network using the new network identifier if the network does exist.

The audio signal may be an audio watermark embedded in an audio track. The audio signal may be a command.

The audio signal may be matched using an audio fingerprinting mechanism.

The plurality of portable computing devices may be co-located, for example, within a cinema screening room.

The network may be a mesh and/or ad-hoc network. The network may be wireless.

The step of creating the new network identifier may also utilise a code common to each portable computing device. The common code may be generated based upon the time of receipt of the audio signal by the portable computing device. The common code may be generated based upon a window of predefined size surrounding the time of receipt. The common code may be generated by the portable computing device.

The method may further include each portable computing device: displaying game images on a screen at the device; receiving input from the user; and processing the input to generate modified game images for display at the device.

The method may further include a main display displaying game images; wherein the main display is visible to a user of each portable computing device. The main display may be a cinema screen.

The audio signal may be generated by an audio system such as a cinema audio system.

Game data may be transmitted between the portable computing devices in the network.

At least some of the game data may be transmitted as UDP packets.

According to a further aspect of the invention there is provided a system for building a network between portable computing devices to facilitate a multiplayer game, including:

a plurality of portable computing devices, each portable computing device configured to receive an audio signal at a microphone at the device, to match the audio signal to one of a plurality of pre-stored games where each game is associated with a game network identifier, to create a new network identifier utilising the matched game network identifier, to create a network using the new network identifier if the network does not exist and to join the network using the new network identifier if the network does exist.

The system may include an audio system configured to generate the audio signals and/or a display configured to display game images relating to the multiplayer game, wherein, during use, the display is visible to a user of each portable computing device.

According to a further aspect of the invention there is provided a multiplayer game system for a cinema auditorium, including:

at least several dozen portable computing devices, each portable computing device configured to receive a trigger signal when located within the cinema auditorium, to create a network identifier utilising the trigger signal, to create an ad-hoc or mesh network using the network identifier if the network does not exist and to join the network using the network identifier if the network does exist.

Other aspects of the invention are described within the claims.

### BRIEF DESCRIPTION OF THE DRAWINGS

Embodiments of the invention will now be described, by way of example only, with reference to the accompanying drawings in which:

FIG. 1: shows a block diagram illustrating a multiplayer game system comprising a plurality of devices connected by mesh network in accordance with an embodiment of the invention;

FIG. 2: shows a block diagram illustrating a portable computing device in accordance with an embodiment of the invention;

FIG. 3: shows a block diagram illustrating a multiplayer game system in accordance with an embodiment of the invention;

FIG. 4: shows a flow diagram illustrating a multiplayer game system in accordance with an embodiment of the invention;

FIG. 5: shows a diagram illustrating a multiplayer game on a system in accordance with an embodiment of the invention; and

FIG. 6: shows a sequence diagram illustrating a multiplayer game method in accordance with an embodiment of the invention.

### DETAILED DESCRIPTION OF PREFERRED EMBODIMENTS

The present invention provides a method and system for creating a network between a plurality of portable computing devices to facilitate a multiplayer game.

The inventors have discovered that a temporary network created between large numbers of portable computing devices, such as smartphones or tablets, can be used to overcome many of the difficulties in the prior art. The inventors have also discovered that a broadcasted trigger signal, such as an audio signal, which is received by each device can be used to synchronise the devices so that they create or join the same network.

An audio trigger signal can be transmitted over the audio systems of cinemas or stadiums so that users located in those areas can receive the signal at their devices. The subsequently created network can be used to provide communications and/or coordination across the devices to provide for a multiplayer game that supports hundreds or thousands of commonly located players without requiring the deployment of local communications hardware or overloading existing localised communications architectures such as cellular networks.

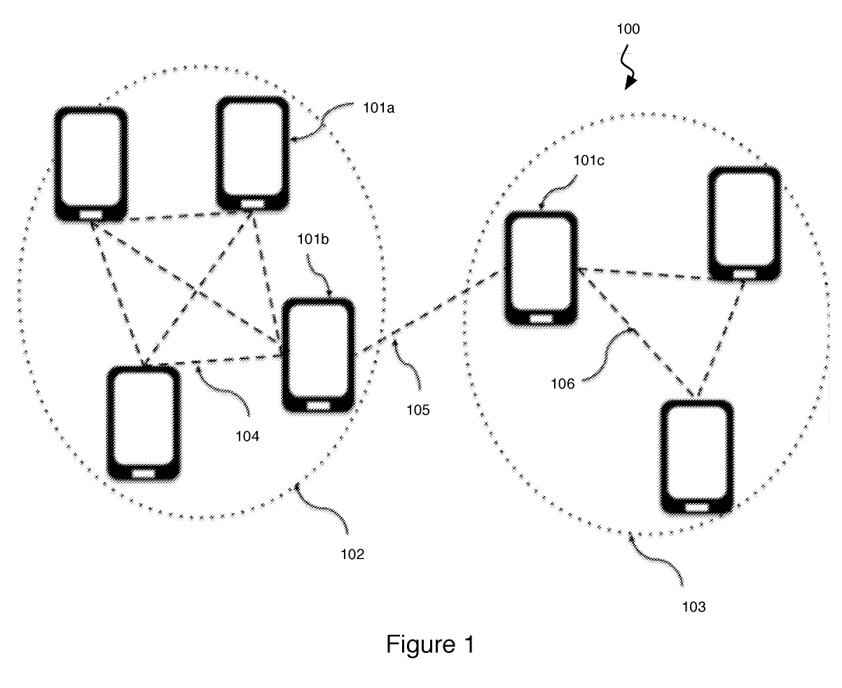

In FIG. 1, a system in accordance with an embodiment of the invention is shown.

A plurality of portable computing devices 101 are shown. The portable computing devices may be mobile smart-phones, tablet, phablets, or smart-watches.

Each of the plurality of portable computing devices 101 is configured for receiving a trigger signal such as an audio signal, for generating a network identifier using the trigger signal and for creating a network using the network identifier if the network does not exist or joining the network of the network identifier if it does exist.

The trigger signal may be transmitted from a locally located transmitter, for example, an audio system. In one embodiment, the trigger signal may be transmitted from one of the portable computing devices 101.

The portable computing devices 101 may match the trigger signal to locally stored information to retrieve information for constructing a network identifier. The construction of the network identifier may utilise dynamic information which may be common to the portable computing devices 101, such as time of receipt of the trigger signal, to ensure that the network identifier is unique or, at least, locally unique.

The portable computing devices 101 may be configured for creating an ad-hoc network where each portable computing device transmits communications directly to every other portable computing device in the network, or a mesh network where sub-networks 102 and 103 are connected by portable computing devices 101b and 101c acting as bridges.

A mesh network consists of a number of devices, including 101a and 101b, each connected to all devices in range (e.g. 104). To reach devices, such as 101c, that are out of range an intermediate device 101b is used to forward 105 the data to the device 101c that is out of range. This device 101c can optionally forward 106 the data to additional devices if needed.

As ad-hoc networks do not forward data to devices that are out of range from other devices, they may be useful within small and medium sized cinema auditoriums.

Whereas because mesh networks forward data to devices out of range of the transmitting device, this allows the network to work better in very large cinema auditoriums and stadiums.

The portable computing devices 101 may utilise the created/joined network to communicate data relating to a multiplayer game played by a user of each portable computing device. The multiplayer game may be a game where the users are competing against one another (such as a racing game or quiz game), cooperating (such as a construction game or RPG) or engaged in team play (such as team-based sports game or real-time space simulators). The multiplayer game may involve synchronous play (racing game with multiple cars on the track at once or real-time space simulator with multiple user controlled spacecraft) or non-synchronous play (turn based platformer or turn-based strategy games). The multiplayer game may involve the users playing in the same game world where a user's actions can affect another (joint play racing game) or in independent game worlds where a user's actions cannot affect another (one car racing game).

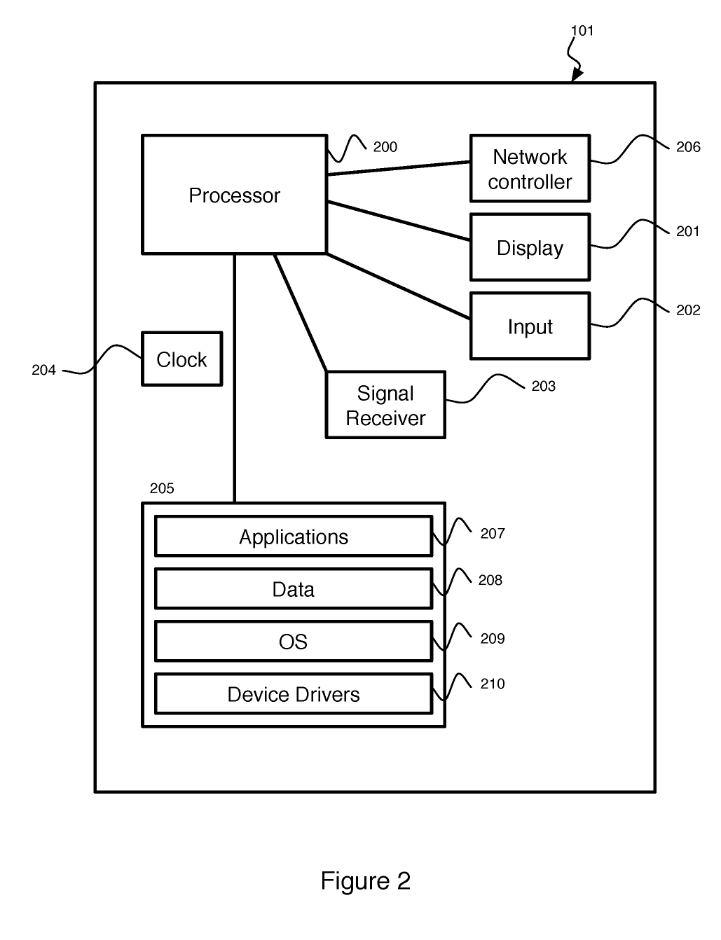

With reference to FIG. 2, a portable computing device 101 for use with the system above will be described.

The portable computing device 101 may include a processor 200, a display 201, an input 202, a signal receiver 203, a digital clock 204, a memory 205, and a network controller 206.

The signal receiver 203 may be a microphone and may be configured for receiving audio signals. The audio signals may include an audio watermark. The audio watermark may comprise a command.

In an alternative embodiment, the signal receiver 203 may be another non-RF signal receiver such as a camera or a RF signal receiver such as Bluetooth LE.

The network controller 206 may be a wireless network controller, such as wifi or

Bluetooth.

The display 201 may be a digital screen such as a LCD, LED or OLED screen, and input 202 may be a pointer-based input, a touch or near-touch input, or be comprised of a plurality of input apparatus such as a touch input, an accelerometer, and/or a gyroscope.

The display 201 and the input 202 may be combined into a single apparatus such as a touch-screen display.

The memory 205 may be configured for storing applications 207, data 208, operating system 209, and device drivers 210. It will be appreciated that the memory 205 may be comprised of one or more of flash memory, RAM, EPROM, ROM, hard-drive, or any other non-transistory digital medium.

The memory 205 may be configured for storing a plurality of game applications and data. Each of the plurality of game applications may be associated with a game network identifier. The game network identifiers may be unique for each game application.

The game applications may comprise game instructions and game-play information. The instructions and/or game-play information may be interpreted by another application executing on the portable computing device 101.

The processor 200 may be configured for processing signals received by the signal receiver 203 and matching the processed signals to one of the plurality of game applications. In one embodiment, the processor 200 is configured for processing a received audio signal to extract a command from an audio watermark. The extracted command is matched to a corresponding stored game application and game network identifier. In an alternative embodiment, the processor 200 is configured for processing the received audio signal using audio fingerprinting to match the fingerprint to one of the plurality of game applications.

The processor 200 may be configured to utilise the game network identifier corresponding to the matched game application to generate a new network identifier.

The new network identifier may be created from the game network identifier and data common to each portable computing device 101. The data common to the receiving devices may be time of receipt of the audio signal. The data may need to be first processed to render it common, for example, where the data is time of receipt this may be rounded to a predefined value (e.g. the nearest 5 minutes) to accommodate for acoustic delay in receipt of the signal by each device 101 which are not necessarily located the same distance from the audio transmitter(s).

The network controller 206 may be utilised to create a network using the new network identifier if the network does not exist, and to join the network when the network already exists.

It will be appreciated that the processor 200 may be configured to utilise instructions to perform some or all of its tasks and that these instructions may be defined as one or more computer programs and stored in the memory 205.

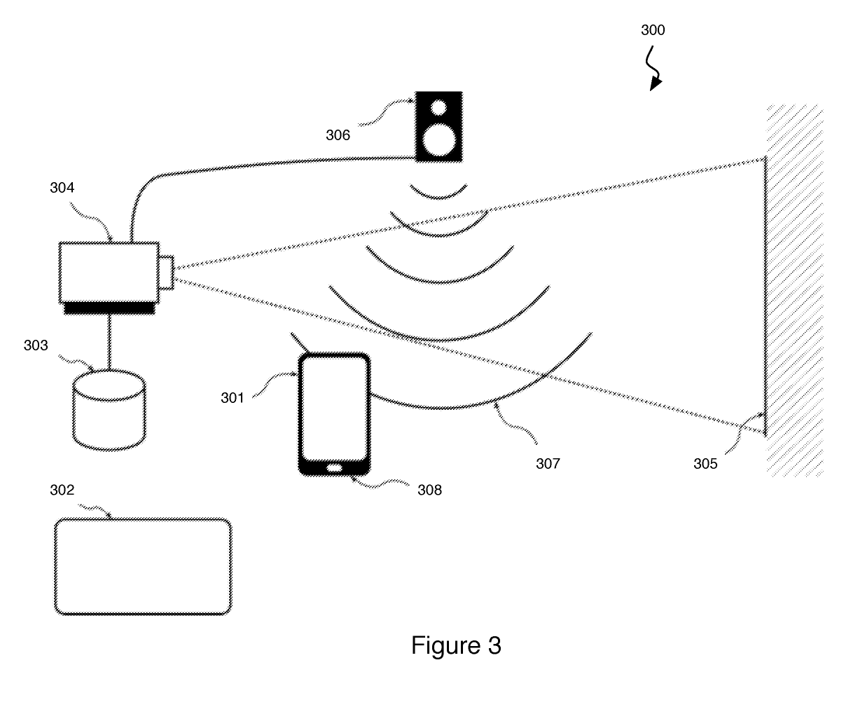

With reference to FIG. 3, a system 300 in accordance with an embodiment of the invention will be described.

The system 300 may include a portable computing device 301. The portable computing device 301 may be configured for receiving game applications and/or data from a server 302. The server 302 may be remote, and may communicate with the portable computing device 301 via one or more communications protocol such as a cellular protocol, a wireless network protocol, and/or a network protocol.

The system 300 may further include a display device 303, a cinema projector 304, a cinema screen 305 and a cinema audio system 306.

In an alternative embodiment, the display device 303 is not provided.

The server 302 may transmit game data to the portable computing device 301 prior to execution of the game applications at each device 301.

The cinema projector 304 is configured for projecting cinema video and/or video game content onto the screen 305. The video game content may be received from the display device.

The display device 303 is configured for transmitting video game content to the cinema projector 304 for display and for switching between its content and cinema video content. The video game content may be entirely pre-stored or it may be dynamically generated. The video game content may be generated in response to information received from the portable computing device 301. The display device 303 may also be configured for switching the cinema audio system over to video game audio from the display device 303.

The cinema audio system 306 may be connected to the display device 303 (for example via the cinema projector 304) and be configured for playing cinema video audio content and for playing video game audio received from the display device 303.

An application executing on the portable computing device 301 may be configured for detecting a trigger in an audio signal in audio 307 transmitted by the cinema audio system 306 and received at a microphone 308 at the portable computing device 301.

The audio signal may be an audio watermark embedded within audio track playing for the video game.

When the application on the portable computing device 301 detects the trigger, it begins playback of the game application associated with that trigger and sets-up or joins a mesh or ad-hoc network.

The display device 303 may join the mesh/ad-hoc network.

The portable computing device 301 may construct the name for the network based upon an identifier for the game application and the time that the trigger is received rounded to the nearest 5 minutes, for example. The network name may be important when games are being played in adjacent cinemas to determine what game the device should join. Audio is generally not clearly transmitted through cinema auditorium walls, whereas wifi signals are typically transmissible through the walls. Using time of receipt of the audio trigger can then ensure that devices 301 within an auditorium join a game begun within the auditorium. In one embodiment, the same game can be started at the same time in adjacent auditoriums to construct a large multi-auditorium game where users of devices 301 within both auditoriums can join the same network and, therefore, the same game. In such an embodiment, a high score leader-board will contain players from both auditoriums and there will only be one winner across the auditoriums.

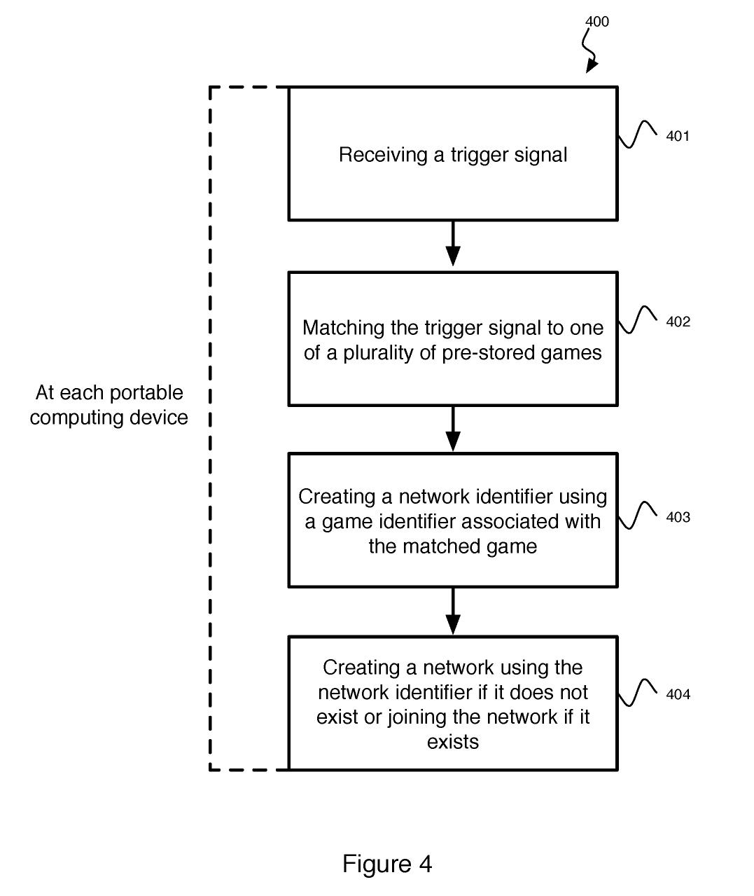

Referring to FIG. 4, a method 400 of building a network between a plurality of portable computing devices to facilitate a multiplayer game will be described.

In step 401, each of a plurality of portable computing devices receives a trigger signal. The trigger signal may come from the same signal generator or generator system.

Preferably the trigger signal is audio because then the audio system of a cinema auditorium can be used to transmit the audio signal. The audio signal may comprise a command.

In step 402, each portable computing device matches the received trigger signal to one of a plurality of pre-stored games. Each game is associated with a game network identifier. The device may match a received signal, where it is an audio signal, by decoding the signal to locate a command and matching the command to a code for one of the pre-stored games. Alternatively, the device may match a received audio signal by using audio fingerprinting to determine an identity for the audio and then matching the identity to a code for one of pre-stored games.

In step 403, each portable computing device generates a new network identifier using the game network identifier. The new network identifier may also be constructed using data common to the portable computing devices. The common data may relate to the trigger signal. The common data may relate to the time of receipt by the portable computing device of the trigger signal. This time of receipt may be rounded, for example, to the nearest 5 minutes.

In step 404, each portable computing device creates a network using the new network identifier if the network does not yet exist, or joins the existing network.

Game play data or results may then be transmitted within the network between the portable computing devices. In one embodiment, another device also joins the network and receives the game play data and results. This other device may process the data and generate game images for display on a screen visible to the users of the portable computing devices.

Game play data may be transmitted as packets using UDP (User Datagram Protocol) within the network, or, alternatively, using TCP (Transmission Control Protocol).

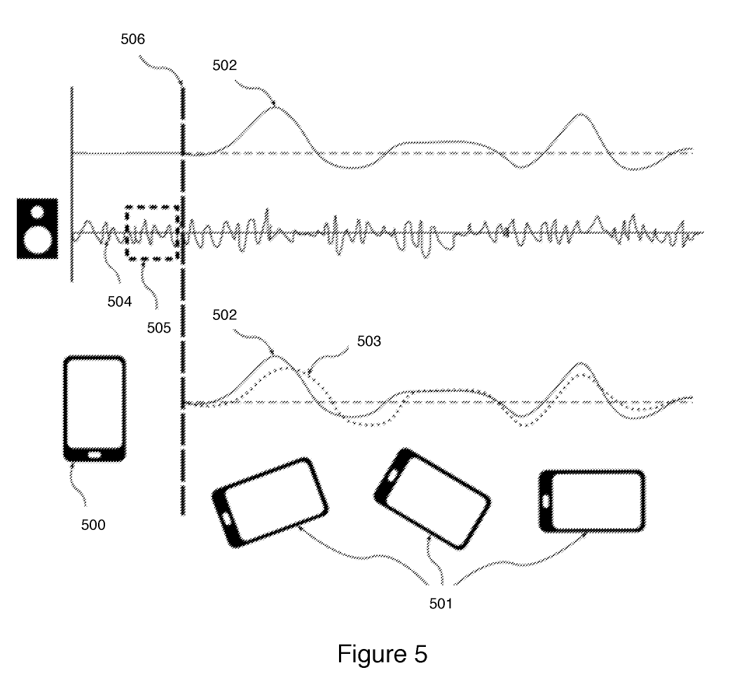

Referring to FIG. 5, an example of a multiplayer game executing on the system of FIG. 3 will be described.

This multiplayer game is a driving game where users of handsets 500 play along to a racing video shown on a cinema display. An app on each handset 500 detects tilting 501 of the device 500 to simulate steering the racing car. The app determines a user's score based upon how closely their steering mimics the movement of the vehicle in the racing video.

To initiate the multiplayer game, the display device in the cinema begins playback of the video game video and audio. The audio includes an audio trigger to construct the network. When the app at each handset 500 receives the audio and detects the audio trigger, it uses the method described in relation to FIG. 4 to build or join an ad-hoc or mesh network.

The driving game example uses pre-recorded master angular/time 502 data that is captured using a special version of the app. The users' score can then be calculated by how accurately users match their handset tilt movements in time with the video to this master data 502 (the difference between 502 and 503). The master data 502 is stored on the server 302 and loaded onto the player's handsets 500 each time they start the app and when the handset 500 can create a connection to the server 302.

To play the game the users' apps are also time synchronized to the video and audio being projected in the cinema. The audio track 504 of the video is modified to include an inaudible AWM data signal 505 that can be detected and decoded into binary data by the app. When the correct code is detected the app starts the game.

Once triggered, the app on each user's handset 500 monitors the angle of left/right tilt of the handset and compares it to the recorded movement data 502. The data items to compare against are calculated using a millisecond offset from the trigger 506. The difference between the recorded data 502 and the user's data 503 is used to score the user. The user receives more points if the movement data 502 closely matches the current handset 501 tilt angle 503.

The user's game name and score with a millisecond timestamp offset from the AWM detection is broadcast to all other handsets 301 and the display device 303 on the mesh/ad-hoc network.

The handsets 301 and the display device 303 receive the scores from all other handsets and then every few seconds the scores within a time window in milliseconds are sorted and a leader-board of the top players is shown on the handsets' 301 screens and cinema screen 305 via the display device 303.

In an alternative embodiment, the display device does not display the leader-board and, therefore, does not need to receive the game names and scores or to even join the ad-hoc/mesh network.

At the end of the game the final scores are broadcast and the winners in 1st, 2nd and 3rd place are shown on each handset 301 and the cinema screen 305. All handsets 301 also show their user's own ranking.

It will be appreciated that although the above example uses audio watermarking that alternative audio triggering solutions could be utilised such as audio fingerprinting.

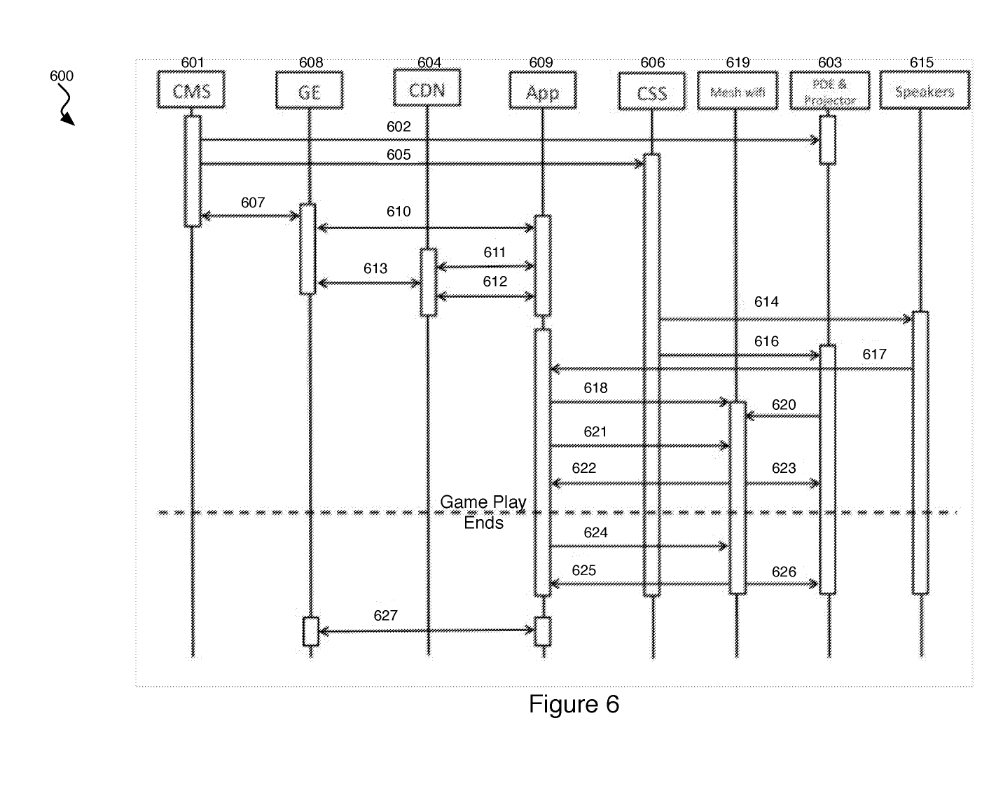

Referring to FIG. 6, a method 600 in accordance with an embodiment of the invention will be described.

This method 600 relates to the creation of a campaign. A campaign includes a new game that is to be deployed for game play at cinemas and may be created for advertising or marketing purposes.

A campaign is created at the CMS (Content Management System) 601 including the encoding of a Digital Cinema Package (DCP)—cinema audio/video data—with an audio watermark (AWM), creation of campaign assets (such as text, images, and angular/timing data) and prize assets.

Information relating to the campaign such as software support for new campaign assets and game play is transmitted 602 to the local game engine 603 at the cinema. This may be performed periodically (such as overnight) via a content distribution network (CDN) 604.

The DCP is transferred 605 to the Cinema Scheduling System (CSS) 606.

The campaign may be tested and approved in the CMS 601 before being transferred 607 to the campaign engine 608 server farm (a cluster of servers behind a load balancer system).

Each time a client app 609 on a user's mobile device runs it synchronizes 610 all the campaign data that matches the user's profile (age/gender) to the phone's internal storage. This includes the angular/time campaign play data and AWM trigger IDs.

The app requests 611 assets for the campaign from the CDN 604 and any media/image assets that the campaign uses are then loaded into the phone's memory via a content distribution network (CDN) 604. The CDN 604 connects the app 609 to a local CDN node to deliver 612 the content. The CDN 604 requests 613 the asset from the campaign engine 608 if it has not already loaded it.

At a later time, the cinema's Cinema Scheduling System (CSS) 606 plays the video (DCP file) on one of the cinema screens.

At the same time, the CSS 606 plays 614 the audio through the cinema sound system 615.

The Cinema Scheduling System (CSS) 606 uses scripting to switch the audio and video inputs to the PDE for a set amount of time and instructs 616 the PDE 603 to start the two way game.

The app 609 on the mobile device then detects the audio watermark (AWM) 617 within the audio using the device's microphone and starts the appropriate pre-stored campaign based upon the AWM trigger ID. The campaign is time synchronized to the audio/video within, for example, 150 ms. The AWM triggers the game to begin on the mobile device using the campaign data preloaded via the CMS 601 and the campaign assets preloaded via the CDN 604.

The campaign metadata stored on the mobile device contains a mesh network name. The mobile devices use this name and the time rounded to the nearest five minutes, for example, to constructed a name for the new network. They then all create and join 618 the mesh network 619 using the constructed name.

The PDE 603 joins 620 the mesh network 619.

Game play starts and each player on the mobile device plays the full game independently and the mobile device of each player broadcasts 621 their scores and other game-play data to all other players via the mesh network 619.

Players receive 622 the broadcast scores from all other players and use these to display the current ranking and number of people playing on the mobile device's screen.

The PDE 623 receives the scores and uses the data to project the on screen leaderboard.

At the end of the game the final scores are broadcast 624 and received 625 by the mobile devices.

Each player calculates the winner, their score and ranking. These are used by each player's app to award the player the predefined prizes (e.g. a coupon for free popcorn).

The PDE receives 626 the final scores broadcast and displays the winner and runner up.

The prizes are then synchronized 627 back to the campaign engine GE 608 when the user next has an Internet connection.

In one embodiment, when the app 609 first runs on a mobile device, it communicates with the game engines 608 and is issued a tamper proof ID (a GUID). The device uses this in all future communications to identify itself to the system.

In one embodiment, all communications use TCP and are protected using 256 bit SSL encryption and the HTTP protocol with a JSON data structures.

In one embodiment, an open source cross platform AllJoyn is used to provide connectivity across the mesh/ad-hoc network 619.

It will be appreciated that any specific technical implementation details can be modified or replaced with other technical specifications or components performing the same function and are provided by way of example only.

It will further be appreciated that at least some of the above methods can be implemented within hardware and/or software.

A potential advantage of some embodiments of the present invention is that by using an audio signal received by all the portable computing devices, a temporary network can be created and joined by all the portable computing devices. This temporary network can be utilised to managed communication and/or coordination for a multiplayer game amongst the users of the portable computing devices. Therefore, the potential advantage of some embodiments of the present invention is that a multiplayer game system can be provided for a large number of participants within existing auditoriums with audio systems.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of applicant's general inventive concept.

1. A method of building a network between a plurality of portable computing devices to facilitate a multiplayer game, including:
each portable computing device:
receiving an audio signal at a microphone at the device;
matching the audio signal to one of a plurality of pre-stored games, each game associated with a game network identifier;
creating a new network identifier utilising the matched game network identifier; and
creating a network using the new network identifier if the network does not exist or joining the network using the new network identifier if the network does exist, exist, wherein a code common to each portable computing device is generated based upon a window of predefined size surrounding a time of receipt of the audio signal by the portable computing device.

2. The method as claimed in claim 1, wherein the audio signal is an audio watermark embedded in an audio track.

3. The method as claimed in claim 1, wherein the audio signal is matched using an audio fingerprinting mechanism.

4. The method as claimed in claim 2, wherein the audio signal includes a command.

5. The method as claimed in claim 1, wherein the plurality of portable computing devices are co-located.

6. The method as claimed in claim 5, wherein the plurality of portable computing devices are co-located within a cinema screening room.

7. The method as claimed in claim 1, wherein the network is a mesh and/or ad-hoc network.

8. The method as claimed in claim 1, wherein the network is a wireless network.

9. The method as claimed in claim 1, wherein the common code is generated by the portable computing device.

10. The method as claimed in claim 1, further including:
each portable computing device:
displaying game images on a screen at the device;
receiving input from the user; and
processing the input to generate modified game images for display at the device.

11. The method as claimed in claim 1, further including:
a main display displaying game images;
wherein the main display is visible to a user of each portable computing device.

12. The method as claimed in claim 11, wherein the main display is a cinema screen.

13. The method as claimed in claim 1, wherein the audio signal is generated by an audio system.

14. The method as claimed in claim 13, wherein the audio system is a cinema audio system.

15. The method as claimed in claim 1, wherein game data is transmitted between the portable computing devices in the network.

16. The method as claimed in claim 15, wherein, at least, some of the game data is transmitted as UDP packets.

17. A system for building a network between portable computing devices to facilitate a multiplayer game, including:
a plurality of portable computing devices, each portable computing device configured to receive an audio signal at a microphone at the device, to match the audio signal to one of a plurality of pre-stored games where each game is associated with a game network identifier, to create a new network identifier utilising the matched game network identifier, to create a network using the new network identifier if the network does not exist and to join the network using the new network identifier if the network does exist, exist, wherein a code common to each portable computing device is generated based upon a window of predefined size surrounding a time of receipt of the audio signal by the portable computing device.

18. The system as claimed in claim 17, including an audio system configured to generate the audio signals.

19. The system as claimed in claim 17, including a display configured to display game images relating to the multiplayer game, wherein, during use, the display is visible to a user of each portable computing device.

20. A multiplayer game system for a cinema auditorium, including:
at least two dozen portable computing devices, each portable computing device configured to receive a trigger signal when located within the cinema auditorium, to create a network identifier utilising the trigger signal, to create an ad-hoc or mesh network using the network identifier if the network does not exist and to join the network using the network identifier if the network does exist, wherein a code common to each portable computing device is generated based upon a window of predefined size surrounding a time of receipt of the trigger signal by the portable computing device.

21. A non-transitory computer readable medium configured for storing a computer program, which when executed by a processor of a portable computing device cause the device to:
receive an audio signal at a microphone of the device;
match the audio signal to one of a plurality of pre-stored games, each game associated with a game network identifier;
create a new network identifier utilising the matched game network identifier; and
create a network using the new network identifier if the network does not exist or joining the network using the new network identifier if the network does exist, wherein a code common to the portable computing device and an other portable computing device is generated based upon a window of predefined size surrounding a time of receipt of the audio signal by the portable computing device and the other portable computing device.
